(19) United States
(12) Patent Application Publication
(10) Pub. No.: US 2025/0272659 A1
(43) Pub. Date: Aug. 28, 2025

(54) BUILDING SUPPLY CHAIN ACCOUNTABILITY WITH ASSET LIFECYCLE ACCOUNTING & STAKEHOLDER VALUE ADDITION USING SERVICE TOKENIZATION

(71) Applicant: HITACHI, Ltd., Tokyo (JP)

(72) Inventors: Malarvizhi SANKARANARAYANASAMY, Mountain View, CA (US); Ravigopal VENNELAKANTI, San Jose, CA (US); Prasun SINGH, San Jose, CA (US)

(21) Appl. No.: 18/587,840

(22) Filed: Feb. 26, 2024

(51) Int. Cl. G06Q 10/101

(52) U.S. Cl. CPC G06Q 10/101

(57) ABSTRACT

Project management of a physical product through a hybrid token composed of fungible tokens and non-fungible tokens, involving processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product; incorporating the hybrid token into a graph having a plurality of hybrid tokens in a hierarchy and distributed across stakeholders, the graph indicative of part lists to be utilized for project fulfillment; executing the hybrid tokens to form smart contracts across each of the stakeholders; and processing corresponding fungible tokens and non-fungible tokens to execute a physical process across each of the stakeholders to form a final product or service associated with the physical product.

### BACKGROUND

### Field

The present disclosure is generally directed to industrial systems, and more specifically, to supply chain accountability through utilizing service tokenization.

### Related Art

Industrial asset and equipment circularity have become of interest because of environmental, policy and asset lifetime value appreciation. However, ensuring product authenticity and functioning while asserting its value through its lifecycle is still an issue even in a linear supply (value) chain. This issue is further exacerbated in a circular chain because the current supply chain is not fully setup for circular activities, which leads to a number of stakeholder occlusions. Once the part is sold, the OEMs lose visibility into the changes/upgrades made on the product on the field. To some extent this issue has been resolved to the OEMs with the warranty and service programs. However, the OEM visibility is conditional on the operator feedback and operational conditions are not reflected in this transaction.

Industrial asset and equipment value chain includes a varied number of participants starting from the OEM and their suppliers on the production side, to the engineers and appraisers on the operational end. Each participant is a direct or indirect contributor to ensuring a proper functioning value chain and also has a defined role. Further, when the business models evolve, the one or more participant/stakeholder may consolidate or distribute the functional contribution to the ecosystem. However, their participants are not informed of the Quality of Service (QoS) specified by the other stakeholders down the chain, and the visibility decreases as the number of participants grows.

For example, with equipment-as-a-service or facility-as-a-service offerings, the OEMs perform the function of producer, authorizer, and additional functions such as an arbiter between the user and the insurance/traders. When the role of the stakeholder changes, the operational structure evolves and with it the accountability and traceability factor on the value chain needs to be reinforced. To envisage the required level of transparency and enforce accountability the numerous service providers in the supply chain need to be incentivized to share the details and touch points need to be coded to ensure the level the service.

In the related art, there are blockchain based enforcements for supply chain application. One related art implementation provides methods for ensuring product verifiability with unique identifiers, and a system that produces a digital signature (cryptographic key pair) as it transcends though the supply chain. Such related art implementations are limited to product verification method descriptions.

In the related art, there are also supply chain simulators. The permissioned network of supply chain participants establishes and obtains simulation-based supply chain KPIs from permissioned data inputs to execute a smart contract. The related art implementation is limited to describing the method to enforcing operational metrics via smart contract and does not consider implementations with operational transgressions.

In the related art, there are also subscription-based services using industrial blockchains. Such related art implementations provide tamper-proof records of manufacturing statistics for a product, a product's history within the larger supply chain, industrial asset usage histories that can be leveraged in connection with lifecycle management, machine usage history for use in connection with subscription-based machine operation, and other such information. Such related art implementations are limited to providing systems and methods to record the process and product histories. Neither stakeholder roles, definitions, nor feedback from these service allocation on the performing agent are used in this formulation.

### SUMMARY

Supply chain traceability and accountability deteriorates as the number of participants in the ecosystem increases and further deteriorates when the component is driven is processed for second/third use. Current multi part operating protocols with point-to-point negotiation creates transaction overheads and friction.

Further, the related art methods and systems are more focused on parts/asset and the stakeholder incentives for sharing the updates, and their service or level of service are not recorded. Stakeholder values are not clear, and ecosystem leverage may be lacking for initiatives such as ESG/Climate. This is mostly because of the unclear pathways for incentivization.

Finally, there is a need for tokenization practice that would link asset tokens and service/utility tokens.

The related art ecosystem with centralized walled gardens and disconnected stakeholders creates high transactional friction, which can further lead to lack of trust and incomplete view into demand signals. Related art implementations attempt to address the above issue through the establishment of the secured blockchain network. Such related art implementations are focused on the establishment of blockchain network among the participatory stakeholders and part traceability. However, because assets can take many forms, their value is more fluid than what is represented in the related art, and the process/service performed on the assets is not considered. Example implementations described herein leverage industrial private blockchain and tokenization to establish a network of participatory agents and tokened asset and services which digitalizes the offering and provides a task-based ownership visible across the value chain. This helps to bridge the gap between transformation in the asset to this actual value cycle and the service performed on it.

Aspects of the present disclosure can involve a method for project management of a physical product through a use of a hybrid token composed of fungible tokens and non-fungible tokens, the method involving processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product; incorporating the hybrid token into a graph having a plurality of hybrid tokens in a hierarchy and distributed across stakeholders, the graph indicative of part lists to be utilized for project fulfillment; executing the hybrid tokens to form smart contracts across each of the stakeholders; and processing corresponding fungible tokens and non-fungible tokens to execute a physical process across each of the stakeholders to form a final product or service associated with the physical product.

Aspects of the present disclosure can involve a computer program storing instructions for project management of a physical product through a use of a hybrid token composed of fungible tokens and non-fungible tokens, the instructions involving processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product; incorporating the hybrid token into a graph having a plurality of hybrid tokens in a hierarchy and distributed across stakeholders, the graph indicative of part lists to be utilized for project fulfillment; executing the hybrid tokens to form smart contracts across each of the stakeholders; and processing corresponding fungible tokens and non-fungible tokens to execute a physical process across each of the stakeholders to form a final product or service associated with the physical product. The computer program and instructions can be stored on a non-transitory computer readable medium and executed by one or more processors.

Aspects of the present disclosure can involve a system for project management of a physical product through a use of a hybrid token composed of fungible tokens and non-fungible tokens, the system involving means for processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product; means for incorporating the hybrid token into a graph having a plurality of hybrid tokens in a hierarchy and distributed across stakeholders, the graph indicative of part lists to be utilized for project fulfillment; means for executing the hybrid tokens to form smart contracts across each of the stakeholders; and means for processing corresponding fungible tokens and non-fungible tokens to execute a physical process across each of the stakeholders to form a final product or service associated with the physical product.

Aspects of the present disclosure can involve an apparatus for project management of a physical product through a use of a hybrid token composed of fungible tokens and non-fungible tokens, the apparatus involving a processor, configured to process a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product; incorporate the hybrid token into a graph having a plurality of hybrid tokens in a hierarchy and distributed across stakeholders, the graph indicative of part lists to be utilized for project fulfillment; execute the hybrid tokens to form smart contracts across each of the stakeholders; and process corresponding fungible tokens and non-fungible tokens to execute a physical process across each of the stakeholders to form a final product or service associated with the physical product.

### BRIEF DESCRIPTION OF DRAWINGS

FIG. 1 an illustration of the industrial compressor ecosystem with participants, in accordance with an example implementation.

FIG. 2 illustrates a table showing the sample set of token standard interfaces.

FIG. 3 is an illustration of the system configuration, in accordance with an example implementation.

FIG. 4 is an illustration of assets and services including tokenization and life cycle accounting, in accordance with an example implementation.

FIG. 5 illustrates an example of sample services with asset and service token, in accordance with an example implementation.

FIG. 6 illustrates an example of asset lifecycle accounting and stakeholder value addition, in accordance with an example implementation.

FIG. 7 illustrates an example table for a sample implementation log, in accordance with an example implementation.

FIG. 8 is an illustration of the initiation workflow, in accordance with an example implementation.

FIG. 9 is an illustration of the update and revaluation workflow, in accordance with an example implementation.

FIG. 10 illustrates the system diagram in accordance with an example implementation.

FIG. 11 illustrates an example implementation for value creation with tokenization and its utilization in a circular supply chain, in accordance with an example implementation.

FIG. 12 illustrates an example of a subgraph that can be generated across the flows of the supply chain.

FIG. 13 illustrates an example of a graph-based system output for token aggregation and disaggregation in accordance with an example implementation.

FIG. 14 illustrates a plurality of organizations that are networked to a management apparatus, in accordance with an example implementation.

FIG. 15 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

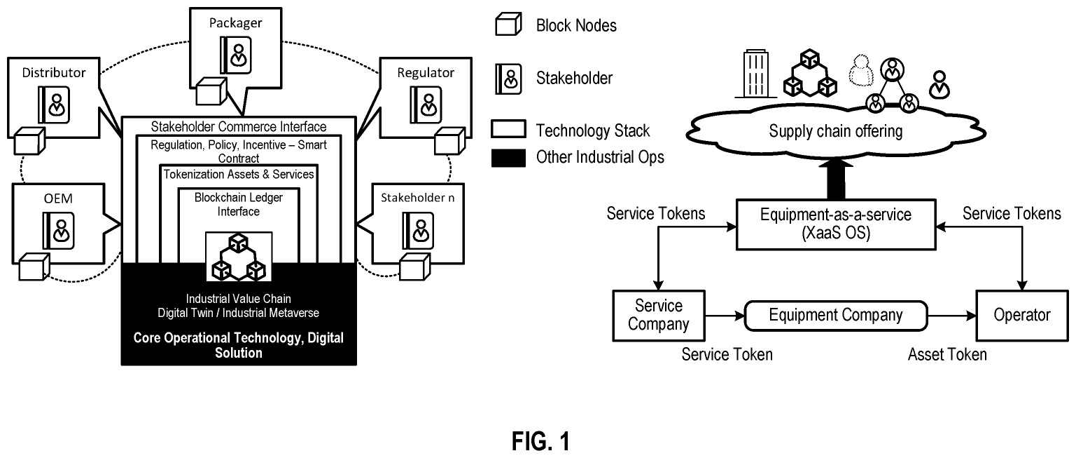

FIG. 1 illustrates a stakeholder ecosystem in an industrial compressor service where the OEM-service company-operator trifactor are integrated via industrial blockchain network with asset and service tokenization designed to deliver equipment-as-a-service offering, in accordance with an example implementation. In this sample implementation the value of the asset, and the stakeholder services are recorded as asset and service tokens respectively and transacted between the stakeholders.

The blockchain technology is used to establish a validated network of participatory agents (stakeholders) and authentication of their service and production value addition incrementally. Tokenization and non-fungible token generation using cryptographic hashing an offshoot of blockchain technology is used here to authenticate product and the service provider simultaneously while automating service allocation to stakeholders.

In example implementations, the tokenization of assets and services is used to provide service (task)-based ownership visible across the value chain. Tokenization is the process of assigning ownership of an asset or the right to use an asset to a token, a discrete unit of the blockchain network that is cryptographically encoded. Tokens are widely used to symbolize ownership of a valuable item while discussing blockchain technology.

Non-Fungible Tokens (NFTs) are unique digital assets with a unique digital signature stored in a smart contract that are the property of a person or a business, and whose record is verified and coded into a blockchain network.

In a first aspect of the present disclosure, stakeholder specific tokens and governing structure are established. Tokens can be any of Asset/service/hybrid token keys and assigned by the stakeholder address. Token composability is expressed based on the order of operations. Ownership tokens are assigned and maintained per stakeholder based on the pre-defined type of ownership (type of token).

In a second aspect of the present disclosure, the asset/operational value addition is identified and validated. The operator and validator statement are published. Stakeholder keys are assigned and linked to a corresponding asset universal identifier (UID) to post stakeholder operation on/with the asset (i.e., value addition).

In a third aspect of the present disclosure, the asset is identified and associated with an evaluation cycle based on comparison with original configuration and all associated key addition based on value addition activity for re-valuation of the asset based on the set of operations identified and performed. The service provider associated with the identification of the task and operation is also identified. The service token is assigned, which is then updated and published on the common ledger.

The most prevailing token standard is based on the ERC20 which provides fungible tokens (i.e., the standard makes all the tokens of the same kind) and ERC721 standard generates unique tokens are generally referred to as NFTs for the Ethereum protocol. Finally, to the last set, the ERCC1155 standard provides methods to generate fungible and non-fungible sets and are referred to as the multi-token standard. Token standards define a common interface for smart contracts to unify and simplify the integration process for various wallets, exchanges, and other services. Token standards distinguish between interchangeable, non-interchangeable, and hybrid tokens. Although the example implementation is described with respect to Ethereum, other protocols may also be utilized to facilitate the desired implementation, and the present disclosure is not limited thereto.

Interchangeable tokens are fungible tokens (i.e., they do not differ from each other). For example, if one token represents a value, then it will be equal to any other token.

Non-interchangeable tokens are NFTs (i.e., they differ from each other). For example, for a tokenized real estate, one token that represents a specific real estate object will not be equal to any other token. Each token stands unique.

Hybrid tokens are a combination of fungible and nonfungible tokens (i.e., creating sets of interchangeable tokens). For example, tokenizing investment portfolios can involve hybrid tokens, wherein each investment portfolio can contain different sets of fungible and non-fungible token sets.

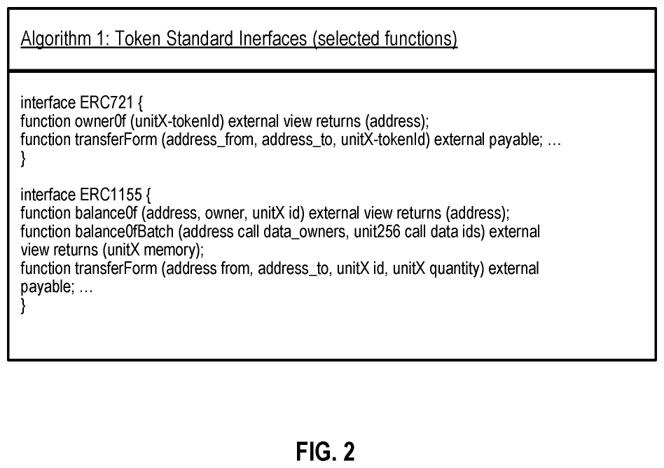

Example implementations described herein we use the differential implementation of tokens such as NFT from the standards. The first set include the usage of non-fungible tokens (NFT) as referred in ERC721 to represent the initial asset configuration and track its modification using token aggregation and disaggregation methods forming composed NFTs and providing derivatives of NFTs. The second set of tokens used here are based on the multi-token/hybrid token implementation, ERC 1155. These tokens are also referred to as utility tokens due to the versatility in its usage. In this work we employ hybrid tokens to assign service value and it is offered to stakeholders that operate on the asset but do not directly own the asset. FIG. 2 provides the token interface listing as specified in the standard.

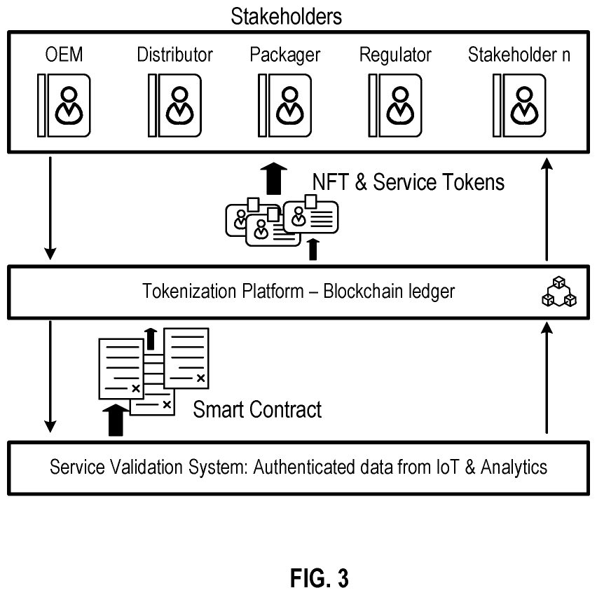

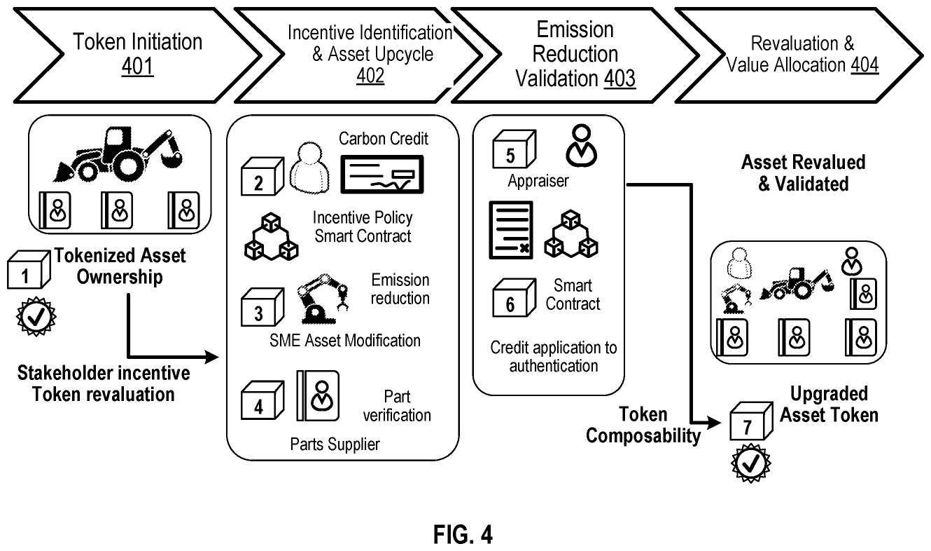

FIG. 3 provides a system view detailing the key interfaces and authentication systems, in accordance with an example implementation. The first step after stakeholder onboarding into the industrial blockchain network, is identification of opportunities for tokenization and this decision is made based on the governing principles as will be described herein. Here we focus on the workflow for the example implementation presented in FIG. 4.

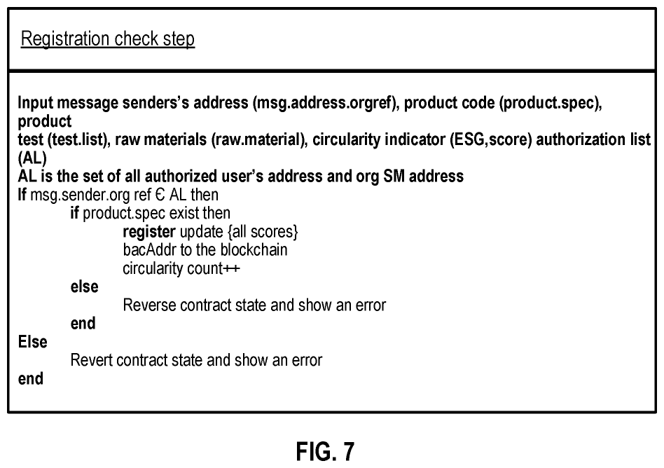

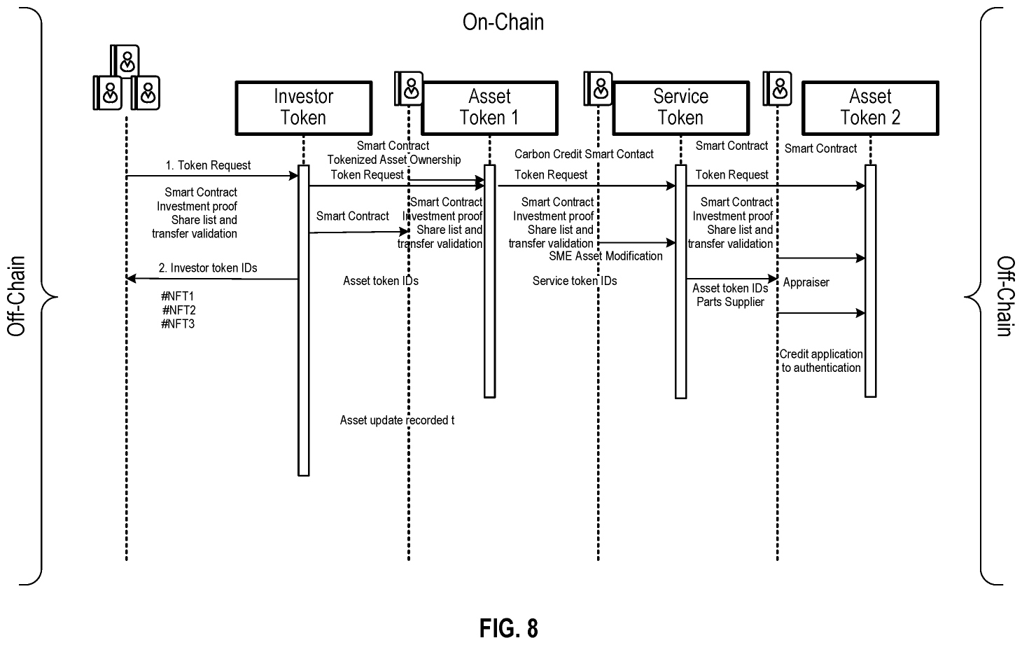

FIG. 4 illustrates the overview of sample implementation for an asset (tractor) passing thorough a second life upcycling based to reduce emission, in accordance with an example implementation. Workflow for the sample implementation of FIG. 4 is described in further detail with respect to FIGS. 7 and 8. Consider an example wherein the stakeholders decide to convert the asset from a fossil fuel-based system to the battery-based system. In the process, the stakeholder needs access to policy incentives made available for the transition to clean energy service and each service provider needs to be incentivized/disincentivized based on the Quality of the Service (QoS) provided, making sure that every stakeholder inclusion or token generation process is backed by profitable business decision for the future is backed by evidence.

For the example use case, traditionally the investors lend money to the producers/owners to buy an asset from the OEM, wherein the asset insurance and value is expected to be amortized over a period of time. Further, during operations, several services such as maintenance and part replacement may be performed, and these functions add on to the existing list of overhead. The service value is never fully realized in the ecosystem. In the proposed implementation, the investors intend to hold an investor token in the form of an NFT that indicates the share value of their contribution to this set of stakeholders. The investor token record into the smart contract provides token value initiation, length of holding and other governing principle regarding token ownership agreed by all the stakeholders. The ownership assignment includes the following steps.

Tokenized Asset Ownership/Token Initiation 401: In the first step, there is a conversion of Physical asset/design to a digital entity. An example of a conversion is a large industrial compressor converted into a digital twin with records and subsystems.

Incentive Identification and Asset Upcycle 402: In the second step, tokenization platforms are used to convert the digital entity into sub-list of tokens (NFT and service token) based on the owner-OEM engagement contract. Asset touch points across the supply chain are recorded.

Emission Reduction Validation 403: The token value assignment and service terms are initiated based on a smart contract. At a later stage in the compressor life cycle. the compressor is revalidated and revaluated with another set of smart contracts according to the upgrade received based on IoT Monitoring, analytics and incentives, and the smart contract is updated.

Revaluation and Value allocation 404: the tokenized asset with its value encoded can be used by owner/investor trade, transfer ownership and revenue generation with another set of smart contracts that lists the history of ownership and other details required to ensure traceability. Seamless ownership transfer and liquidation tokens can also be done if the stakeholders agree to setup an industrial blockchain vault within the permissioned network of participants. This service can be used during asset repurposing and recertification.

Tokenized entity can involve OEM Tokens, Service Tokens, Performance Tokens, Investor/REIT Tokens, Utility Tokens, Customer Tokens, and so on. Through such a tokenized entity, problems such as supplier system visibility, risk minimization, circularity and asset upcycle, revaluation, ecosystem integration, and rapid change implementation can be addressed.

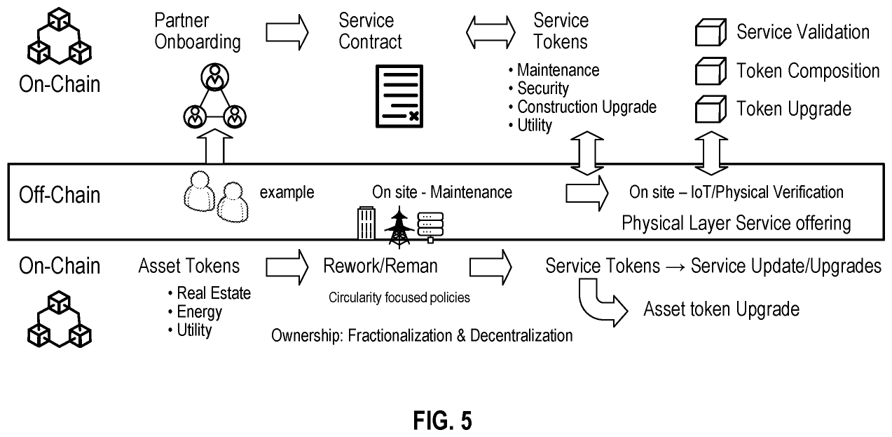

FIG. 5 illustrates an example of sample services with asset and service token, in accordance with an example implementation. A set of service features generalized as QoS across the different types of stakeholders to determine the value of the service token and asset value token. QoS can be utilized to determine the number of fractionalizations of the assets and also if such fractionalization lead to a profitable outcome.

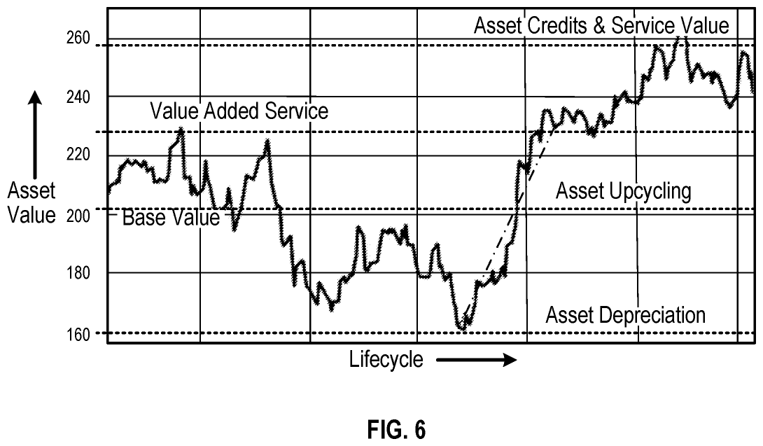

FIG. 6 illustrates an example of asset lifecycle accounting and stakeholder value addition, in accordance with an example implementation.

The governing formulations can involve fractionalized ownership and service valuation, as well as an assessment as to whether the token creation is profitable action or not as follows:

$$P = 0 if profit else P = 1$$

$$Logit ( pi ) = 1 / ( 1 + exp ( - pi ) )$$

$$ln ( pi / ( 1 - pi ) ) = Beta\_ 0 + Beta\_ 1 * X\_ 1 + … + B\_k * K\_k$$

Token value estimation at any given time based on the service (e.g., QoS qualified from a regulating entity via SM) ownership distribution for OEM profit maximization. The following probabilities for n class assignment can be computed based on asset base value.

$$P ( X = 1 ) = 1 - P ( X > 1 ) ,$$

$$P ( X = 2 ) = P ( X > 1 ) - P ( X > 2 ) ,$$

$$;$$

$$;$$

$$P ( X = n ) = P ( X > n - 1 )$$

The above binary and multiclass classification and assignment of token value can be evaluated using machine learning models such as logistic regression, SVM, random forests, based on asset and QoS features influence overall asset value.

The formulation for the ownership distribution, changeover and assignment model can be as follows:

Oₚᵣ(tᵢ,locᵢⱼ)=Set of service options ƒ or [Om₁,Om₂,Omₙ. . . Omₙ,u]

Service,R=sequence of [Oₚᵣ₁,Oₒᵣ₂, . . . Oₚᵣₙ,UOₚᵣ]

Here, there are services, R providing the marginal likelihood or the model evidence for the service function with respect to a specific demand representation such as:

if Oₚᵣ₁(tᵢ,locᵢⱼ) then Oₚᵣ₂(tᵢ₊ₚ,loc_{i+pj+q})

The joint probability distribution for asset and services if presented via a graphical model with the service stations as the nodes and edges as the service order is given by

$$P ( {X}_{1} , {X}_{2} … . {X}_{n} ) = {\prod }_{i = 1}^{n} P ( {X}_{i} \vert {\prod }_{i} = {\prod }_{i = 1}^{n} {j}_{{x}_{i} \vert {\prod }_{i}}$$

Conditional distributions can be estimated for each mode, and this becomes the value function for the incentivization RL model.

In example implementations for carbon credit regulators, a separate registered policy watch application which monitors external incentives such as carbon credits, regulatory updates such as phasing out high volt equipment, and updates the smart contract based on the ecosystem participants set condition.

In example implementations, the optimized point is based on the RUL of the asset as well as policy watch incentives chosen based on supply chain optimization analytics. Given the policy point condition and its encoding into the system, example implementations can activate a smart contract to call for a part upgrade which automates the next set of task assignments such as design/part modification and supplier allocation.

FIG. 7 illustrates an example table for a sample implementation log, in accordance with an example implementation. As shown in FIG. 7, the registration check step can take as input the sender address, product code, product test, raw materials, circularity indicator, authorization list and so on. Based on the input, updates can be registered and recorded to the blockchain or can be rejected.

FIG. 8 is an illustration of the initiation workflow, in accordance with an example implementation. At first a token request is made by potential investors or stakeholders with the requisite smart contract, investment proof, share list and transfer validation. As illustrated in the example flow, each stakeholder receives a corresponding smart contract token request along with the smart contract information.

In the example of FIG. 8, in example implementations for small medium enterprise (SME) asset modification or parts supplier, based on the smart contract execution in previous step and selection of the next stakeholder, information to modify the existing asset setup to meet the incentive policy requirement are sent to the next stakeholder. Examples of such information can include the Small Medium Enterprise (SME authorized by OEM) which alters the engineering design of a subsystem and float quote for parts to build the new subsystems. The new quote is now recorded in smart contract chain and so are the part modifications are also coded into the digital twin via the token updates. Here the value addition activity recorded by the SME is linked to the asset upgrade and the value is allocated post asset testing and post appraisal.

In the example of FIG. 8, in example implementations for the appraiser or for the credit application to authentication, the appraiser re-evaluates the new asset value and sends data to the smart contract with their unique digital signature to authenticate the new value of the asset and as a byproduct the service smart contracts assigns a value of the service provided by each of the intermediary service providers in the system.

Hence in the above example implementations both the asset value and the service value are (re) assigned and the smart contract updates the tokens of the stakeholders based on their ownership. Based on their token type either a new token with composable feature from the past token list value is created or linked token is created with multiple.

However, a technical problem still exists when a smart contract is implemented across organizations with different keys. Hence this is addressed here with a set of hash keys that presents the process flow of the asset upgrade activity presented in the example of the upgraded asset token as follows.

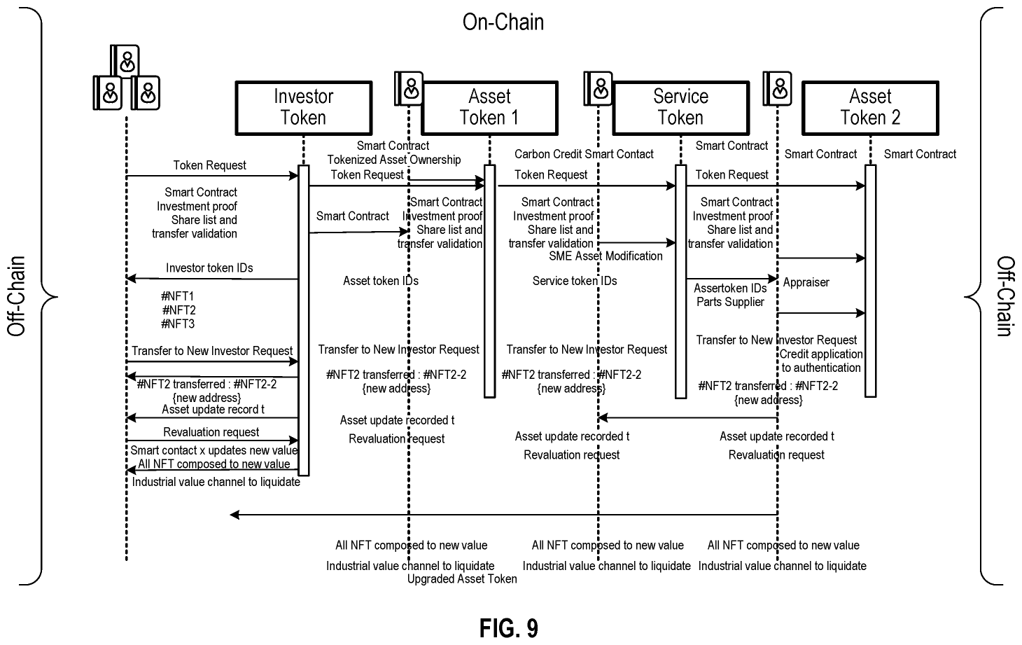

FIG. 9 is an illustration of the update and revaluation workflow, in accordance with an example implementation. The upgraded asset token uses the composability feature of NFT to update the existing tokens and reflect changes via smart contract post authorization from the appraiser/regulator. Directed Acyclic Graph (DAG) based token coding that accounts for cross business chained token address creation can also be utilized. Smart contracts can also be used to assign the new value to the token and redistribute the return in the form of a digital record to the investors whose value can be recovered using the industrial value described earlier. The new asset token includes the history of asset modification encoded and also the service workflow. Such example implementations provide traceability of the asset and also enforces accountability of the service provided in the value chain.

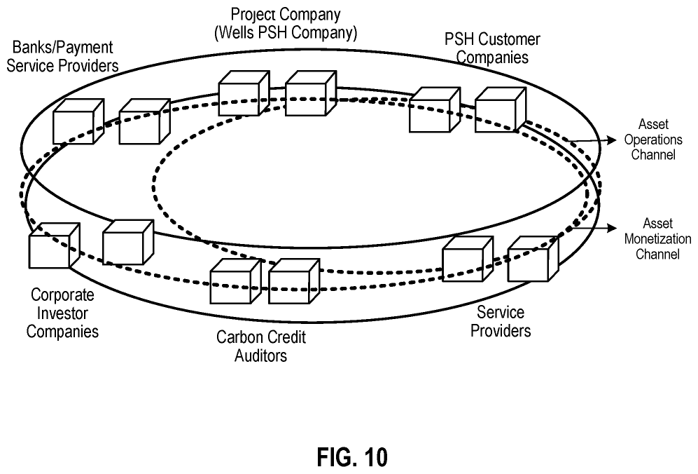

FIG. 10 illustrates the system diagram in accordance with an example implementation. As illustrated in FIG. 10, various stakeholders from payment service providers, to customer companies, to carbon credit auditors and so on can be interconnected via a blockchain. The asset monetization channel can include service providers, carbon credit auditors, project company, and customer companies. The asset operations channel can include additional parties such as the payment service providers and the corporate investor companies.

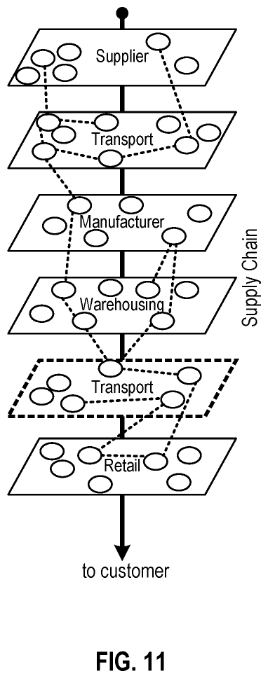

FIG. 11 illustrates an example implementation for value creation with tokenization and its utilization in a circular supply chain, in accordance with an example implementation. Illustrated in FIG. 11 is a typical supply chain work flow from planning, to suppliers, to transport, manufacture, storage, and retail. Example implementations establish the supply chain workflow as a DAG, along with the submodules of each portion of the supply chain workflow. The advantage of utilizing a DAG is that the system hierarchy is maintained, and processing of hybrid tokens from any of the entities in the DAG can also be conducted quickly. The fungible and non-fungible tokens to be used to form the hybrid token are decided based on traversal of the DAG.

Use of the DAG can also provide a desired level of abstraction, in accordance with the desired implementation. The transport echelon can be abstracted to different domains and problem spaces. The level of abstraction can also be determined from selecting desired submodules of the supply chain flow based on the domain detail or the abstraction.

With regards to sub-graph generation, creating subgraphs from a base graph based on certain conditions is a common task in graph theory and network analysis. The mathematical formulation for this process typically involves defining a subgraph G′ from a base graph G such that G′ satisfies a list of conditions C. A high level formulation is as follows.
Let G=(V,E) be the base graph where V is the set of vertices and E is the set of edges.
Define G′=(V′,E′) as a subgraph of G where:
V′⊆V
E′⊆E
For all ‘e’∈E′, the endpoints of e′ are in V′
G′ satisfies a list of conditions C={c1,c2, . . . ,cn}

The conditions C could include constraints such as vertex degree, edge weights, connectivity, or any property relevant to the specific application.

The actual generation of G′ can involve algorithms such as subgraph isomorphism, graph traversal, or optimization procedures, depending on the conditions listed in C.

To implement this mathematically, algorithmic steps that detail the traversal or selection process respecting the conditions C can be used. Each condition ci would have an associated mathematical representation, such as an inequality for weights or a predicate for vertex properties.

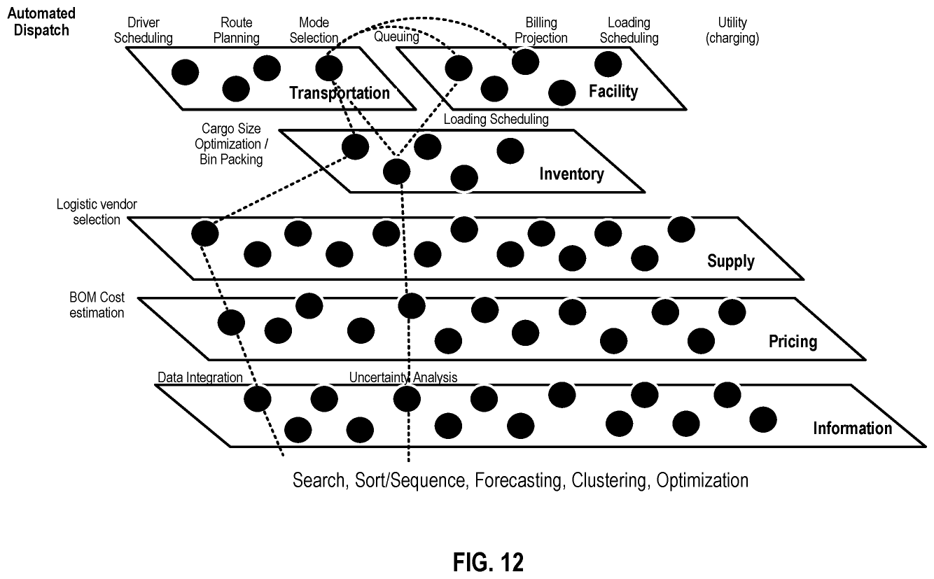

FIG. 12 illustrates an example implementation of a subgraph that can be generated across the flows of the supply chain. Based on the task represented in the top model layer sub graphs are generated with the above-mentioned methods traveling through the layers (representing the supply chain function) with nodes representing the appropriate stakeholder providing the service.

Example implementations described herein can use subgraph aggregation to generate a new token or project. To mathematically formulate the aggregation of subgraphs from a graph G based on valuation, define a function ƒ to evaluate the worth of subgraphs G′. Given a graph G=(V,E), with a valuation function ƒ:V∪E→R, the objective is to find a subgraph G′=(V′,E′) that maximizes ƒ(G′) under specific constraints.

Formally:
V′⊆V
E′⊆E where for each e′∈E′, the endpoints of e′ are in V′
The valuation of the subgraph G′, denoted as ƒ(G′), is calculated based on a specific aggregation of the valuations of its vertices and edges, such as ƒ(G′)=Σv∈V′ƒ(v)+Σe∈E′ƒ(e)
ƒ(G′) is maximized subject to any additional constraints that may apply, such as the size of V′ or E′, or other graph properties like connectivity.

The aggregation process involves selecting vertices and edges that together maximize the valuation function while respecting the imposed constraints.

Similarly, example implementations described herein can conduct disaggregation for value isolation. The mathematical formulation for disaggregation based on valuation in a graph G would involve identifying subgraphs G′ where the vertices and edges satisfy a valuation function ƒ. A high level approach is as follows.

Given a graph G=(V,E) with a valuation function ƒ:V∪E→R, and a threshold T, find all subgraphs G′=(V′,E′) such that:
V′⊆V
E′⊆E where for each e′∈E′, the endpoints of e′ are in V′
The valuation of the subgraph G′, denoted as ƒ(G′), is calculated based on a specific aggregation of the valuations of its vertices and edges, such as ƒ(G′)=Σv∈V′ƒ(v)+Σe∈E′ƒ(e)
ƒ(G′) meets a certain condition, such as ƒ(G′)≤T or ƒ(G′) being maximized under given constraints.

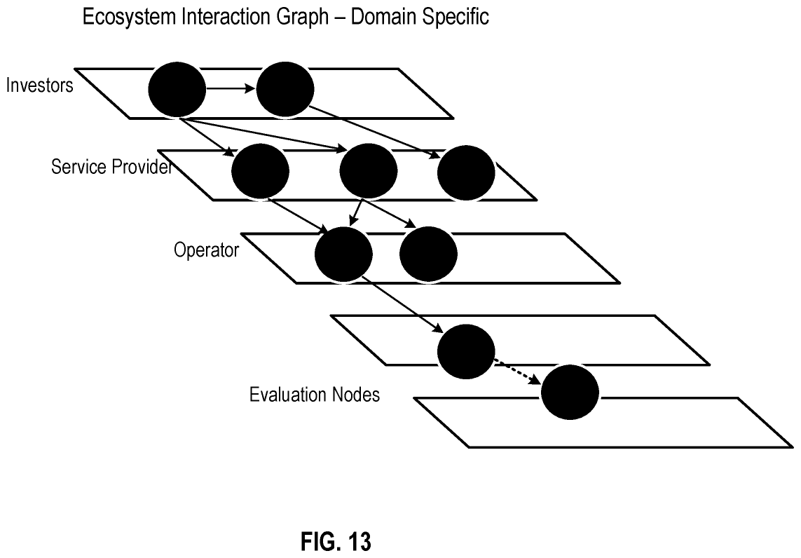

FIG. 13 illustrates an example of a graph-based system output for token aggregation and disaggregation in accordance with an example implementation. Specifically, FIG. 13 illustrates a one probable combination of subgraph selected for function execution out of all the given probabilities of the stakeholder network.

Systems and methods described herein can facilitate value creation with tokenization and its utilization in a circular supply chain.

The value of the asset token estimation and projection as the asset life progresses. The fluctuations of the asset valuation can occur based on registered maintenance records and appraiser's evaluation record implemented based on smart contracts.

Example implementations described herein also facilitate a system to record the asset and service ownership changeovers in an asset lifecycle and methods with example implementation that details the modes of transaction between the stakeholder in the supply chain based on the activity of engagement. Additionally, the example implementations implement an asset token with linked smart contract address to the digital entity which hold the asset history and where its changes are reflected every time the token upgrade call is used. This ensures traceability even in a circular and long tailed value chains.

Example implementations also use DAG based token coding that accounts for cross business chained token address creation. This cross-organization engagement setup helps to break over point-to-point view problem and execute new policy or programs across the ecosystem without overhead.

Example implementations also facilitate a service token which includes incentives and allocation of return service for each value-added activity in a supply chain, which also declutters stakeholder value and makes the system more inclusive. Example implementations can define each stakeholder task and their return clearly in the smart contracts which is made available before task execution.

Hybrid tokens involving asset tokens and service tokens are also proposed here for stakeholder value realization. Example implementations also facilitate a supply chain specific application for linking asset token and service token throughout asset lifecycle which makes both asset upgrades traceable and service provider accountable. Token upgrades and/or composability can be established across different stakeholder organization and updating the record in cross organization smart contract.

In addition, the example implementations correcting the incentive structure for new initiatives (like emission tracking) with a trusted and inclusive ecosystem. Example implementations account for value creation in new initiatives through token composability and can be applied across industrial sectors to integrate ecosystem.

Further, the example implementations can provide a function stack to build on top of available tokenization services and assess the value of the asset and services across supply and at any point of the life cycle. Token changeover and transaction methods provide control over value transfers. Example implementations further facilitate establishment of circular supply chain and designed function to address the requirements of a circular value chain.

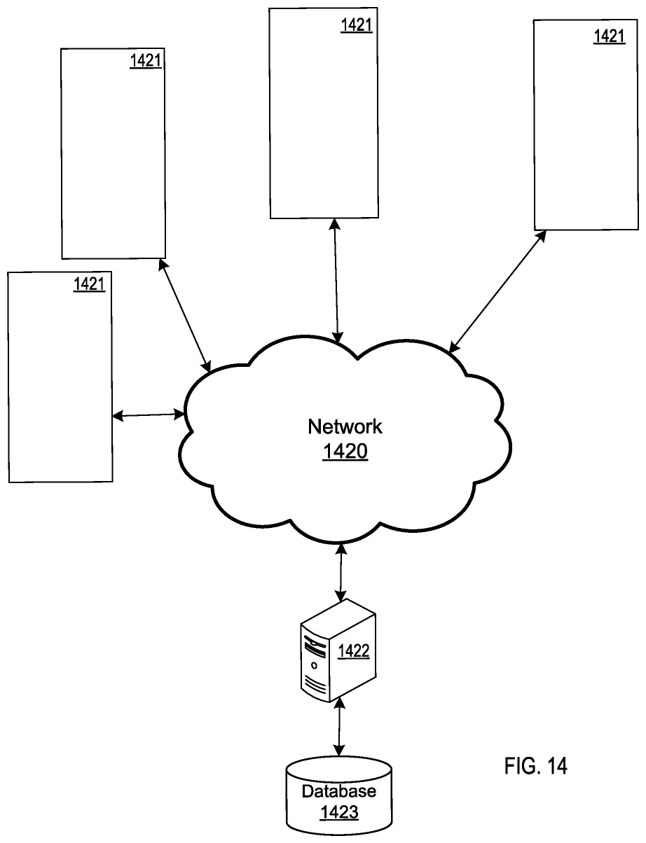

FIG. 14 illustrates a plurality of organizations that are networked to a management apparatus, in accordance with an example implementation. One or more organizations 1421 (e.g., stakeholders, providers in the supply chain, etc.) are communicatively coupled to a network 1420 (e.g., local area network (LAN), wide area network (WAN)) through the corresponding network interface of the devices or servers associated with the organizations 1421, which is connected to a management apparatus 1422. The one or more organizations 1421 may or may not be associated with sensors, depending on the desired implementation. The management apparatus 1422 manages a database 1423, which contains data, tokens and manages blockchain across each of the organizations 1421. In alternate example implementations, the data can be stored in a central repository or central database such as proprietary databases that intake data from the organizations 1421, or systems such as enterprise resource planning systems, and the management apparatus 1422 can access or retrieve the data from the central repository or central database.

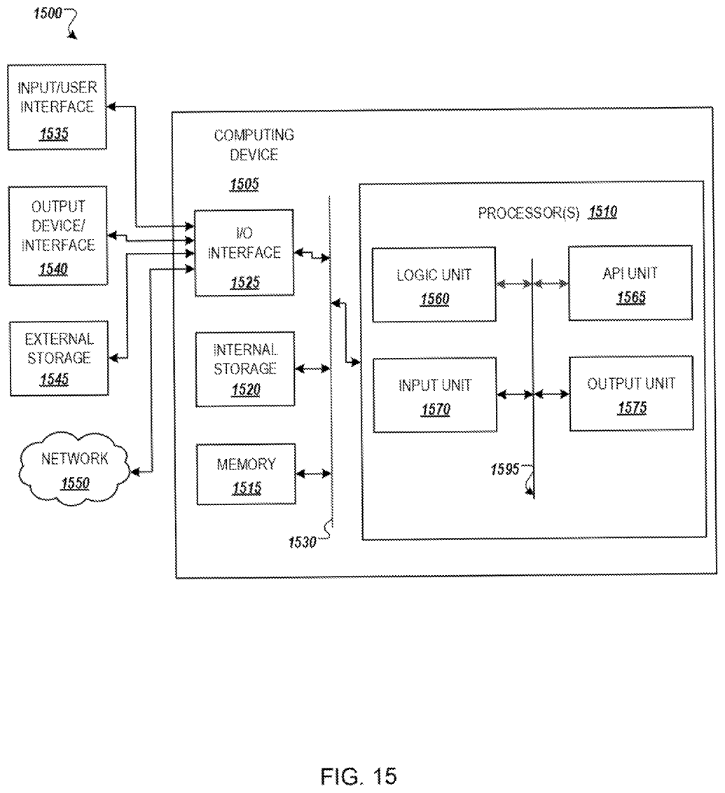

FIG. 15 illustrates an example computing environment with an example computer device suitable for use in some example implementations, such as the management apparatus 1422 to facilitate the functionality of the systems described herein. Computer device 1505 in computing environment 1500 can include one or more processing units, cores, or processors 1510, memory 1515 (e.g., RAM, ROM, and/or the like), internal storage 1520 (e.g., magnetic, optical, solid state storage, and/or organic), and/or I/O interface 1525, any of which can be coupled on a communication mechanism or bus 1530 for communicating information or embedded in the computer device 1505. I/O interface 1525 is also configured to receive images from cameras or provide images to projectors or displays, depending on the desired implementation.

Computer device 1505 can be communicatively coupled to input/user interface 1535 and output device/interface 1540. Either one or both of input/user interface 1535 and output device/interface 1540 can be a wired or wireless interface and can be detachable. Input/user interface 1535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1540 may include a display, television, monitor, printer, speaker, braille, or the like. In some example implementations, input/user interface 1535 and output device/interface 1540 can be embedded with or physically coupled to the computer device 1505. In other example implementations, other computer devices may function as or provide the functions of input/user interface 1535 and output device/interface 1540 for a computer device 1505.

Examples of computer device 1505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1505 can be communicatively coupled (e.g., via I/O interface 1525) to external storage 1545 and network 1550 for communicating with any number of networked components, devices, and systems, including one or more computer devices of the same or different configuration. Computer device 1505 or any connected computer device can be functioning as, providing services of, or referred to as a server, client, thin server, general machine, special-purpose machine, or another label.

I/O interface 1525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1500. Network 1550 can be any network or combination of networks (e.g., the Internet, local area network, wide area network, a telephonic network, a cellular network, satellite network, and the like).

Computer device 1505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1510 can execute under any operating system (OS) (not shown), in a native or virtual environment. One or more applications can be deployed that include logic unit 1560, application programming interface (API) unit 1565, input unit 1570, output unit 1575, and inter-unit communication mechanism 1595 for the different units to communicate with each other, with the OS, and with other applications (not shown). The described units and elements can be varied in design, function, configuration, or implementation and are not limited to the descriptions provided. Processor(s) 1510 can be in the form of hardware processors such as central processing units (CPUs) or in a combination of hardware and software units.

In some example implementations, when information or an execution instruction is received by API unit 1565, it may be communicated to one or more other units (e.g., logic unit 1560, input unit 1570, output unit 1575). In some instances, logic unit 1560 may be configured to control the information flow among the units and direct the services provided by API unit 1565, input unit 1570, output unit 1575, in some example implementations described above. For example, the flow of one or more processes or implementations may be controlled by logic unit 1560 alone or in conjunction with API unit 1565. The input unit 1570 may be configured to obtain input for the calculations described in the example implementations, and the output unit 1575 may be configured to provide output based on the calculations described in example implementations.

Processor(s) 1510 can be configured to execute a method or instructions for project management of a physical product through a use of a hybrid token composed of fungible tokens and non-fungible tokens, including processing a selection of the fungible tokens and the non-fungible tokens to be incorporated into the hybrid token, the non-fungible tokens representative of physical assets (e.g., each of which can have unique identifiers) to be used in the physical project, the fungible tokens representative of services to apply to the physical assets to fulfill the physical assets and services for forming the physical product; incorporating the hybrid token into a graph having a plurality of hybrid tokens in a hierarchy and distributed across stakeholders, the graph indicative of part lists to be utilized for project fulfillment; executing the hybrid tokens to form smart contracts across each of the stakeholders; and processing corresponding fungible tokens and non-fungible tokens to execute a physical process across each of the stakeholders to form a final product or service associated with the physical product. The physical process can be any process indicated by the token, such as but not limited to, transporting a part, manufacturing a part, assembling parts together to form the physical product or a portion thereof, executing maintenance or quality control over a part, and so on in accordance with the desired implementation.

Processor(s) 1510 can be configured to execute the method or instructions as described above and further involve generating a valuation of the hybrid token for the each of the stakeholders based on ownership distribution and service associated with the physical product. In example implementations, the asset and services combine the valuation throughout the entire (asset/project) lifecycle hence also provides projected returns for future operations in addition to the current value of the asset.

Processor(s) 1510 can be configured to execute the method or instructions as described above, wherein the processing corresponding fungible tokens and non-fungible tokens to execute a physical process across each of the stakeholders to form the final product or service associated with the physical product involves aggregating one or more of the corresponding fungible tokens, non-fungible tokens, and hybrid tokens into a single token to represent the final product.

Processor(s) 1510 can be configured to execute the method or instructions as described above, wherein the processing corresponding fungible tokens and non-fungible tokens to execute a physical process across each of the stakeholders to form the final product or service associated with the physical product comprises disaggregating one or more of the hybrid tokens based on the physical process.

Processor(s) 1510 can be configured to execute the method or instructions as described above, and further involve forming an asset token representative of the final product or the physical product with the service associated with the physical product, the asset token being a hybrid token, the asset token representing ownership stakes for the final product or the physical product across the stakeholders.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for project management of a physical product through a use of a hybrid token composed of fungible tokens and non-fungible tokens, the method comprising:
processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product;
incorporating the hybrid token into a graph having a plurality of hybrid tokens in a hierarchy and distributed across stakeholders, the graph indicative of part lists to be utilized for project fulfillment;
executing the hybrid tokens to form smart contracts across each of the stakeholders;
processing corresponding fungible tokens and non-fungible tokens to execute a physical process across each of the stakeholders to form a final product or service associated with the physical product.

2. The method of claim 1, further comprising generating a valuation of the hybrid token for the each of the stakeholders based on ownership distribution and service associated with the physical product.

3. The method of claim 2, wherein the valuation comprises a current valuation of the physical product and projected returns according to future operations associated with the hybrid token.

4. The method of claim 1, wherein the processing corresponding fungible tokens and non-fungible tokens to execute a physical process across each of the stakeholders to form the final product or service associated with the physical product comprises aggregating one or more of the corresponding fungible tokens, non-fungible tokens, and hybrid tokens into a single token to represent the final product.

5. The method of claim 1, wherein the processing corresponding fungible tokens and non-fungible tokens to execute a physical process across each of the stakeholders to form the final product or service associated with the physical product comprises disaggregating one or more of the hybrid tokens based on the physical process.

6. The method of claim 1, further comprising forming an asset token representative of the final product or the physical product with the service associated with the physical product, the asset token being a hybrid token, the asset token representing ownership stakes for the final product or the physical product across the stakeholders.

7. A non-transitory computer readable medium, storing instructions for project management of a physical product through a use of a hybrid token composed of fungible tokens and non-fungible tokens, the instructions comprising:
processing a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product;
incorporating the hybrid token into a graph having a plurality of hybrid tokens in a hierarchy and distributed across stakeholders, the graph indicative of part lists to be utilized for project fulfillment;
executing the hybrid tokens to form smart contracts across each of the stakeholders;
processing corresponding fungible tokens and non-fungible tokens to execute a physical process across each of the stakeholders to form a final product or service associated with the physical product.

8. The non-transitory computer readable medium of claim 7, the instructions further comprising generating a valuation of the hybrid token for the each of the stakeholders based on ownership distribution and service associated with the physical product.

9. The non-transitory computer readable medium of claim 8, wherein the valuation comprises a current valuation of the physical product and projected returns according to future operations associated with the hybrid token.

10. The non-transitory computer readable medium of claim 7, wherein the processing corresponding fungible tokens and non-fungible tokens to execute a physical process across each of the stakeholders to form the final product or service associated with the physical product comprises aggregating one or more of the corresponding fungible tokens, non-fungible tokens, and hybrid tokens into a single token to represent the final product.

11. The non-transitory computer readable medium of claim 8, wherein the processing corresponding fungible tokens and non-fungible tokens to execute a physical process across each of the stakeholders to form the final product or service associated with the physical product comprises disaggregating one or more of the hybrid tokens based on the physical process.

12. The non-transitory computer readable medium of claim 8, the instructions comprising forming an asset token representative of the final product or the physical product with the service associated with the physical product, the asset token being a hybrid token, the asset token representing ownership stakes for the final product or the physical product across the stakeholders.

13. An apparatus for project management of a physical product through a use of a hybrid token composed of fungible tokens and non-fungible tokens, comprising:
a processor, configured to:
process a selection of the fungible tokens and the non-fungible tokens to be incorporated into the hybrid token, the non-fungible tokens representative of physical assets to be used in the physical project, the fungible tokens representative of services to apply to the physical assets to fulfill the physical assets and services for forming the physical product;
incorporate the hybrid token into a graph having a plurality of hybrid tokens in a hierarchy and distributed across stakeholders, the graph indicative of part lists to be utilized for project fulfillment;
execute the hybrid tokens to form smart contracts across each of the stakeholders;
process corresponding fungible tokens and non-fungible tokens to execute a physical process across each of the stakeholders to form a final product or service associated with the physical product.

14. The apparatus of claim 13, the processor further configured to generate a valuation of the hybrid token for the each of the stakeholders based on ownership distribution and service associated with the physical product.

15. The apparatus of claim 14, wherein the valuation comprises a current valuation of the physical product and projected returns according to future operations associated with the hybrid token.

16. The apparatus of claim 13, wherein the processor is configured to process corresponding fungible tokens and non-fungible tokens to execute a physical process across each of the stakeholders to form the final product or service associated with the physical product by aggregating one or more of the corresponding fungible tokens, non-fungible tokens, and hybrid tokens into a single token to represent the final product.

17. The apparatus of claim 13, wherein the processor is configured to process corresponding fungible tokens and non-fungible tokens to execute a physical process across each of the stakeholders to form the final product or service associated with the physical product by disaggregating one or more of the hybrid tokens based on the physical process.

18. The apparatus of claim 13, the processor further configured to form an asset token representative of the final product or the physical product with the service associated with the physical product, the asset token being a hybrid token, the asset token representing ownership stakes for the final product or the physical product across the stakeholders.
